(19) United States
(12) Patent Application Publication
(10) Pub. No.: US 2015/0302110 A1
(43) Pub. Date: Oct. 22, 2015

(54) DECOUPLING FRONT END AND BACK END PAGES USING TAGS

(71) Applicant: Alibaba Group Holding Limited, George Town (KY)

(72) Inventors: Minhui Deng, Hangzhou (CN); Kunli Luo, Hangzhou (CN)

(21) Appl. No.: 14/683,526

(22) Filed: Apr. 10, 2015

(30) Foreign Application Priority Data
Apr. 21, 2014 (CN) 201410160709.8

(51) Int. Cl. G06F 17/30; H04L 29/08; G06F 17/21

(52) U.S. Cl. CPC G06F 17/30905; G06F 17/212; H04L 67/02

(57) ABSTRACT

Using tag-based program development is disclosed, including: receiving a request for a front end page; identifying a tag identifier associated with a location in the front end page; obtaining a tag entity corresponding to the tag identifier; executing the tag entity to obtain an execution result; rendering the front end page based at least in part by setting the execution result in the location in the front end page; and providing the rendered front end page to be presented.

### CROSS REFERENCE TO OTHER APPLICATIONS

This application claims priority to People's Republic of China Patent Application No. 201410160709.8 entitled A TAG-BASED METHOD FOR PROGRAM DEVELOPMENT, A TAG-BASED METHOD FOR RESPONDING TO PAGE REQUESTS, AND DEVICES FOR SAME, filed Apr. 21, 2014 which is incorporated herein by reference for all purposes.

### FIELD OF THE INVENTION

The present application relates to a field of information technology. In particular, the present application relates to techniques for a tag-based page program development.

### BACKGROUND OF THE INVENTION

Traditional Java Platform, Enterprise Edition (J2EE) development is primarily based on a three-layer architectural model. That is, there is a presentation layer (which is sometimes referred to as a “User Interface Layer” or “UIL”), a business logic layer (which is sometimes referred to as a “BLL”), and a data access layer (which is sometimes referred to as a “DAL”). In some cases of complex system development, the business logic layer may be split into two to three layers, which are all variants on the three-layer architectural model system. The presentation layer is for providing an interface to the user (e.g., a user interface). The presentation layer generally makes use of a template engine such as JSP, Velocity, or FreeMarker and is ultimately manifested in the form of an HTML page (including, for example, JS, CSS, etc.). The business logic layer is for processing data business logic. The business logic entities of the business logic layer are responsible for the corresponding data access layer entities. Generally, a business logic layer will invoke the data access layer multiple times in accordance with business logic needs. The data access layer is for directly performing data operations, such as adding, deleting, revising, updating, searching, or performing other tasks in connection with data.

Program development based on the three-layer architecture model as described above is generally divided into front end development and back end development. Front end development implements presentation layer functions and back end development implements business logic layer and data layer functions. Because a business logic entity is responsible for a corresponding front end page in the development process, there needs to be collaboration between the front end development and the back end development. If a front end page is adjusted, generally the back end program code will also need to be adjusted accordingly. For example, when the front end page needs additional data, it becomes necessary to revise the business logic layer code corresponding to that front end page so that the business logic layer can make more of the needed calls for the additional data via the data access layer. When the front end page needs less data, it also becomes necessary to revise the business logic layer code corresponding to the front end page so that the business logic layer can make fewer calls for the data via the data access layer.

Such a high degree of coupling between front end and back end development lowers the speed of development. In addition, the page rendering processes that result from such a development approach operate with relatively low efficiency.

### BRIEF DESCRIPTION OF THE DRAWINGS

Various embodiments of the invention are disclosed in the following detailed description and the accompanying drawings.

FIG. 1 is a diagram showing an embodiment of a system for tag-based program development.

FIG. 2 is a flow diagram showing an embodiment of a process for tag-based program development.

FIG. 3A shows an example of a conventional design flow of program development.

FIG. 3B shows an embodiment of a design flow of program development in accordance with various embodiments described herein.

FIG. 4 is a diagram showing an embodiment of a system for tag-based program development.

FIG. 5 is a flow diagram showing an embodiment of a process of using tag-based program development.

FIG. 6 is a diagram showing an embodiment of a system for using a tag-based program development.

FIG. 7 is a functional diagram illustrating an embodiment of a programmed computer system for using a tag-based program development.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of tag-based program development are described herein. In various embodiments, a business function corresponding to a front end page is decomposed into one or more basic function units where each basic function unit comprises a portion or a component of the business function. In various embodiments, the one or more basic function units are packaged into one or more corresponding tag entities. In some embodiments, a “tag entity” comprises a set of program code that performs a portion of the business function. In various embodiments, corresponding relationships are established between corresponding tag identifiers and the one or more tag entities. In various embodiments, a tag identifier corresponding to a tag entity is included in data associated with the front end page at a location that uses data layer data that is configured to be obtained by the tag entity.

A request for the front end page is received. A tag identifier associated with a location in the front end page is identified. A tag entity corresponding to the tag identifier is obtained. The obtained tag entity is executed to obtain an execution result. The front end page is rendered based at least in part by setting the execution result in the location in the front end page. The rendered front end page is provided to be presented.

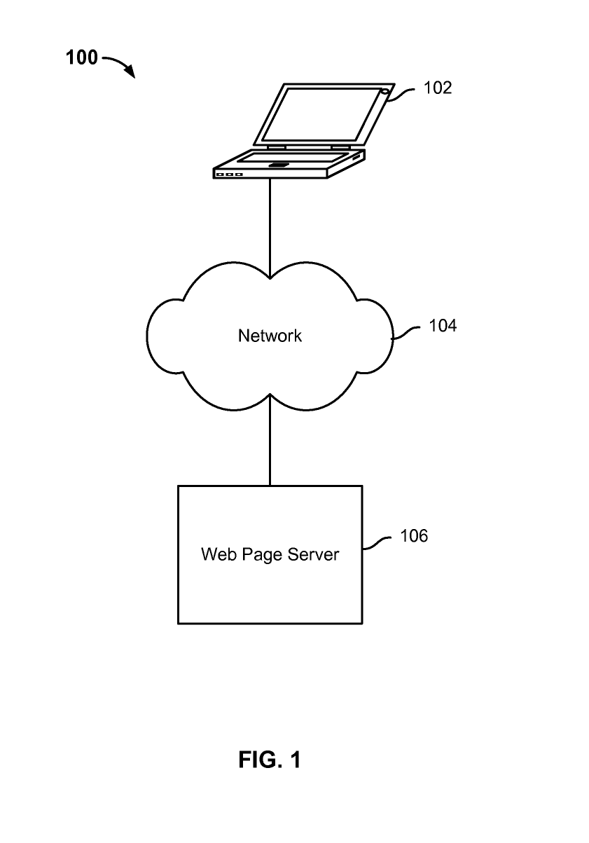

FIG. 1 is a diagram showing an embodiment of a system for tag-based program development. In the example, system 100 includes client device 102, network 104, and web page server 106. Network 104 includes any high-speed data networks, telecommunications networks, and/or any other type of network. In various embodiments, client device 102 is configured to communicate with web page server 106 over network 104.

Web page server 106 is configured to store data associated with one or more front end pages to be requested by and rendered for client devices, such as client device 102. During the development of a particular front end page, a business function corresponding to the front end page is first determined. The business function corresponding to the front end page addresses the business needs of the front end page. For example, a business function of a front end page can provide the current visitor to the page with a personalized greeting and also information about a current offer on a product. In various embodiments, the business function is divisible and so is decomposed into one or more basic function units. A basic function unit comprises a portion or a component of the business function. Each basic function unit is packaged into a tag entity, which comprises a set of program code that when executed, is configured to obtain a dynamic/variable piece of data from a data layer. A tag identifier is determined for each tag entity and corresponding relationships between tag entities to tag identifiers are stored. Data (e.g., markup language) that describes how to render the front end page is modified such that each location in the front end page that requires data that can be obtained by a tag entity from a data layer is set with the tag identifier corresponding to that tag entity. The modified data associated with each front end page is stored by web page server 106.

Different front end pages that require the same data to be obtained from the data layer can include the same tag identifier corresponding to the tag entity that is configured to obtain such data. As such, the same tag entities can be called by and therefore shared among multiple front end pages. Allowing a tag entity to be accessed by multiple front end pages increases the reusability of programming code.

A user can request to access a front end page using client device 102. For example, the user can select a hyperlink associated with the front end page in a web browser application executing at client device 102 to request the front end page. Web page server 106 is configured to receive the request to access the front end page from client device 102. Web page server 106 is configured to retrieve the stored data associated with the front end page and render it. In various embodiments, to “render” a front end page includes to compose the front end page using markup language associated with the front end page and also any dynamic/variable content that is obtained for the front end page using tag entities. In rendering the front end page, web page server 106 is configured to identify in the data associated with the front end page, a tag identifier. Web page server 106 is then configured to obtain the tag entity corresponding to the tag identifier and execute the tag entity to obtain an execution result. Executing the tag entity causes a piece of dynamic/variable data that is to be rendered at the front end page to be obtained from the data layer. Web page server 106 is also configured to render static content (e.g., content not associated with a tag identifier) in the data associated with the front end page. Web page server 106 is configured to render the static content of the front end page along with the dynamic content that is obtained via executing one or more tag entities associated with the front end page to generate the completely rendered front end page. Web page server 106 is configured to send the completely rendered front end page to client device 102 for client device 102 to present at a display screen for the user.

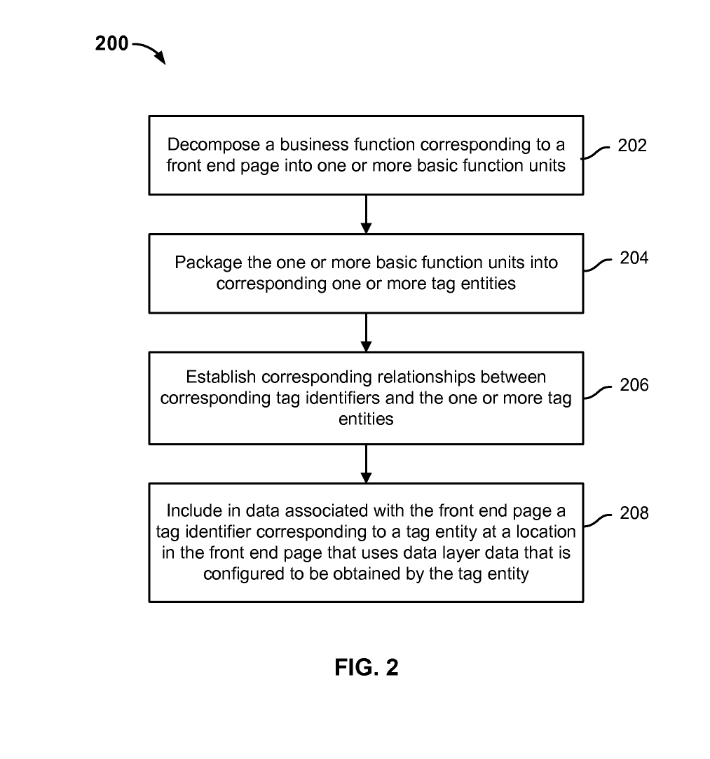

FIG. 2 is a flow diagram showing an embodiment of a process for tag-based program development. In some embodiments, process 200 is implemented at system 100 of FIG. 1. In some embodiments, process 200 is an automated process that is implemented by computer programming code.

In some embodiments, process 200 uses Java programming language as a development language. In some embodiments, process 200 is deployed in a Linux system environment. In some embodiments, process 200 can use programming languages other than Java and/or be deployed in environments other than Linux.

At 202, a function corresponding to a front end page is decomposed into one or more basic function units.

Conventionally, a business function is set up for each front end page in a presentation layer. The business function corresponding to a front end page addresses the business need of the front end page. A business need may be taken as a whole and viewed as one business function or as a combination of multiple basic function units. Conventionally, the business need of a front end page is addressed by one business function, which is implemented by a business logic entity that uniquely corresponds to that front end page. Conventionally, the business logic entity is configured to make calls to a data layer to obtain at least some of the dynamic data that needs to be rendered at the front end page. For example, the business logic entity comprises a set of program code that is used to obtain at least the dynamic data that is to be rendered at the front end page.

As mentioned above, the business function that addresses the business need of a front end page is a business logic entity, which in turn can be divisible into one or more basic function units. As such, a business function corresponding to a front end page can be decomposed into one or more individual basic function units. In some embodiments, a “basic function unit” refers to a portion or a component of a business function associated with a front end page. In some embodiments, a “basic function unit” comprises a piece of program code that is configured to perform a portion or a component of a business function. In some embodiments, in decomposing a business function into one or more basic function units, factors such as the extent of code reusability is considered. That is, the decomposition of business functions should increase the reusability of basic function units as much as possible. In some embodiments, the basic function units that are obtained through decomposition are considered to be the minimum units that can be used to form a business function.

At 204, the one or more basic function units are packaged into corresponding one or more tag entities.

Each basic function unit is packaged into a tag entity. In various embodiments, a “tag entity” is a set of program code that can be individually called by one or more front end pages, as will be described in further detail below. In some embodiments, a tag entity comprises a set of Java code. In some embodiments, packaging a basic function unit into a tag entity comprises formatting the piece of program code of a basic function unit into a format associated with a tag entity.

As will be described in further detail below, business logic entities with one-to-one correspondences with front end pages are replaced by tag entities that can be shared among different front end pages, such that the reusability of code among different front end pages can be promoted. As such, the programming code used to implement front end pages can be made more modular and less coupled to the business logic layer.

In some embodiments, particularly in the event that business functions corresponding to multiple respective front end pages are decomposed, there could be some redundancy between the resulting basic function units. Different front end pages may be associated with the same basic function units because the front end pages may require the same calls to the data layer for data. In some embodiments, the resulting basic function units decomposed for one or more front end pages are deduplicated (e.g., the duplicate basic function units are removed/discarded). In some embodiments, if the basic function units are not deduplicated, then the tag entities that are derived from the basic function units are deduplicated (e.g., the duplicate tag entities are removed/discarded).

At 206, corresponding relationships between corresponding tag identifiers and the one or more tag entities are established.

A tag identifier is established for each tag entity and the corresponding relationship between each tag entity and its corresponding tag identifier is stored. In various embodiments, a “tag identifier” comprises an identifier or a name of a tag entity that can be used to obtain/call/execute the tag entity.

In some embodiments, steps 202, 204, and 206, as described above, are implemented as part of a back end-based development while step 208, as will be described below, is implemented as part of a front end-based development.

At 208, a tag identifier corresponding to a tag entity is included in data associated with the front end page at a location in the front end page that uses data layer data that is configured to be obtained by the tag entity.

If the data (e.g., markup language) for the front end page has not yet been developed, then new data (e.g., markup language) for the front end page is written to include a tag identifier at one or more location(s) in the front end page at which the tag entity corresponding to the tag identifier is needed. In some embodiments, a “location” in a front end page comprises a position or a relative placement among the content to be rendered and presented in the front end page. If data for the front end page already exists, then the existing data is updated to replace a piece of program code associated with a basic function unit with a tag identifier of a corresponding tag entity that was packaged from that basic function unit. As a result of adding tag identifiers into the data of a front end page and/or replacing program code of a front end page with tag identifiers, there is no longer a need to have a conventional correspondence between the development of a business logic entity to the development of a front end page. Rather, in various embodiments, the dependence between the business logic layer (and subsequently, the data layer) and the front end page is removed, and the back end development can thus proceed independently of the front end development. By embedding tag identifiers in front end page data, there is no longer a conventional need to relate the front end page to a specific logic entity in the business logic layer of the back end. As a result, the front end page development need not rely on the back end development. In general, in various embodiments, the back end development can be decoupled from the front end development, thus removing the constraining dependence between the progress of the front end page development and the progress of the back end page development that had traditionally impacted development efficiency.

Conventionally, front end pages and business logic entities of the business logic layer are inter-related. That is, conventionally, a business logic entity is responsible only for the business need of its corresponding front end page and is not responsible for the business needs of other front end pages. Also, conventionally, the data of a front end page can only call the business logic entity to which it was set to correspond and not business logic entities that correspond to other front end pages. Put another way, conventionally, the relationship between each business logic entity and its corresponding front end page is private or one-to-one. However, in practice, the same data may be replicated across multiple front end pages. As result, conventionally, the same program code was often included in each business logic entity corresponding to each front end page that shared the same data. However, the redundancy of program code across business logic entities corresponding to different front end pages leads to inefficiency.

As such, in various embodiments, business functions corresponding to front end pages are decomposed into basic function units and then packaged as tag entities. As will be described in further detail below, the same tag entities can be called by multiple front end pages to avoid the need to copy the same program code into the front end pages. Put another way, if there is a need for the same data by different front end pages, then the different front end pages can each call the same tag entity to perform the same operation(s) and processing in order to obtain the needed data. As a result, one tag entity may be shared by different front end pages, which makes the tag entities “public” in a sense. Thus, during program development, it is sufficient to insert the same tag identifier in multiple front end pages instead of writing and/or inserting the same program code multiple times. Thus, the amount of code that is needed to present a front end page is reduced and the maintenance costs of the front end page are also lowered.

While the steps of 202, 204, 206, and 208 are shown to take place in that sequence in process 200, such an order is merely an example and in actual implementation, step 208 does not need to be executed after the completion of steps 202, 204, and 206. Because steps 202, 204, and 206 involve back end development and step 208 involves development of a front end page as described above, in various embodiments, the developments of the back end and the front end are bound by a low level of coupling. Therefore, in actual implementation, step 208 may be performed before the completion of steps 202, 204, and 206 and/or at least partially in parallel with the performance of steps 202, 204, and 206.

In some embodiments, after the basic function units have been packaged as tag entities, the tag entities and their corresponding tag identifiers are registered in a specialized tag entity pool. In some embodiments, the specialized tag entity pool comprises a new logic layer that a front end page can access/query/call to obtain the tag entity associated with a tag identifier that is included in the data of the front end page. Thus, when a front end page needs to use a tag entity, it can use the tag identifier corresponding to that tag entity as a basis for accessing the corresponding tag entity in the specialized tag entity pool. In response to the call from the front end page including a tag identifier, the specialized tag entity pool will search for and acquire the corresponding tag entity and execute the acquired tag entity to obtain the needed data from the data layer. Different front end pages may include the same tag identifier(s) and a front end page may include multiple tag identifiers, depending on the needs of the front end pages. The specialized tag entity pool logic layer can be thought of as “public” and “transparent” with respect to the presentation layer above it. The specialized tag entity pool logic layer is public because of the fact that the front end pages in the presentation layer can access the specialized tag entity pool logic layer for tag entities as needed. The specialized tag entity pool logic layer is transparent because how the tag entities acquire, via accessing the data layer, the data needed that is needed by the presentation layer is invisible to the presentation layer.

Given the various embodiments of the program development as described herein, subsequent business adjustments are made very convenient:

In a first example of a subsequent business adjustment, when new data needs to be added to a front end page in order to implement a new business service, two kinds of situations may emerge: In the first situation, the existing specialized tag entity pool already has the tag entity for acquiring the new data associated with the new business service. In this first situation, all that needs to be done is to set this existing tag identifier in the data of the front end page to implement the new business service. In the second situation, the existing specialized tag entity pool does not have the tag entity for acquiring the new data associated with the new business service. In this second situation, a new tag entity for acquiring the new data associated with the new business service can be registered in the specialized tag entity pool in order to implement this new business service. Moreover, in this second situation, the registration of the new tag entity will not affect other tag entities or tag settings in front end pages. Conventionally, when new data needs to be added to a front end page to implement a new business service, the business logic entity corresponding to this front end page would also need to be modified, which then requires revision of the corresponding code of the business logic layer so as to increase access to the data layer.

In a second example of a subsequent business adjustment, when relevant data in a front end page needs to be reduced to implement a new business service, certain data needs to be removed from the front end page data. In this case, the tag identifier corresponding to a tag entity that is no longer to be called for the front end page can simply be eliminated from the data of the front end page. By simply removing the tag identifier, the corresponding tag entity will no longer be called and used to obtain data via the data layer. Conventionally, although it is not necessary to revise (e.g., delete) back end program code in response to a change such as removing data from a front end page, the failure to revise (e.g., delete) program code means that each time the business logic entity corresponding to the front end page is run, the corresponding code that is no longer needed will likewise be compiled and executed. However, the execution of this no longer needed code will not produce any meaningful result and is therefore a waste of system resources.

In general, the various embodiments of the program development as described herein provide a flexible design in which new business services can be easily added to front end pages. As more tag entities that can implement basic function units are added to the specialized tag entity pool layer, the likelihood that a new business service can be implemented by an already existing tag entity and therefore not require the generation of a new tag entity increases. It may even be possible that developing a new front end page will only require the use of already existing tag entities, which adds efficiency by avoiding the need to perform any corresponding back end development for the front end page.

The following is an example of code associated with a tag entity. The example below includes a portion of the tag entity is written in XML and can be created as an XML file:

<?xml version=“1.0” encoding=“GBK”?>
<!DOCTYPE tags SYSTEM “tag-def-1.0.dtd”>
<tags>

<type name=“memberEntity” description=“memberEntity”

classes=“com.alibaba.plouto.tag.model.entity.MemberEntity”>

<tag name=“member” type=“memberEntity”
ref=“$beans.member” />

<tag name=“memberId” description=“UserId”>

#set($result=$this.memberInfo.memberId)

</tag>

</type>
</tags>

After the tag entity file is created, an analytic program for XML files can be used to run an XML file analysis. This analytic program could be, for example, DOM and DOM4j. After the tag entity file is resolved into one or more tag entities, the tag entities are packaged into a correspondence table that stores corresponding relationships between keys (for identifying the tag identifiers) and values (for expressing tag entities). For example, the correspondence table can be accessible to and/or stored by the specialized tag entity pool logic layer. This correspondence table is a table that indicates corresponding relationships between tag identifiers and tag entities. For the example tag entity above, the tag identifier is “tags.member.memberId,” and the tag entity is “$this.memberInfo.memberId.” Tag entity registration is completed immediately after the correspondence table is established.

The following is an example of code associated with a front end page that includes a tag identifier to call a corresponding tag entity. The example below includes a portion of the markup data associated with the front end page that includes a call (using the tag identifier “tags.member.memberId”) to the example tag entity (“$this.memberInfo.memberId”) for which code is described in the example above:

<link rel=“stylesheet” pos=“head” data-sc-pos=“head”

href=“http://abc123.com/css/detail/module/dressprocessing/mod/order-action-min.css” />

<div class=“mod-detail-purchasing-single mod ”>

<div class=“obj-order”>

<div class=“unit-detail-order-action”>

<a hidefocus=“true” data-type=“order” trace=“addtoorder1”

target=“_blank”

href=“http://example.htm?supplierVaccountId=$!{tags.member.memberId}”

class=“orange-btn do-purchase” > </a>

</div>
</div>

</div>

</div>

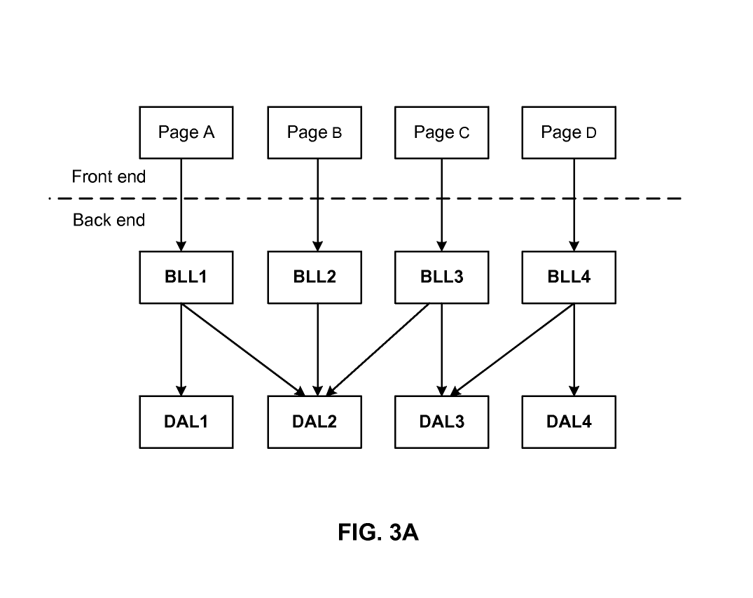

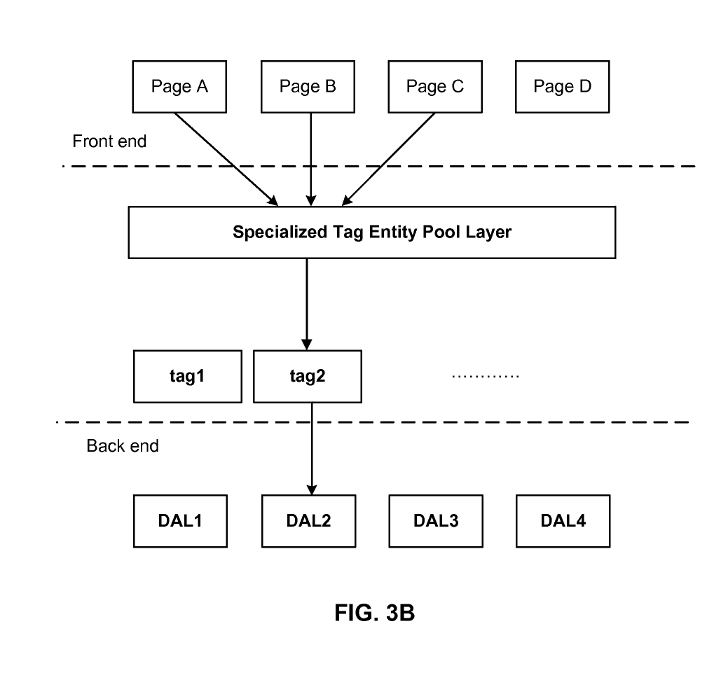

FIGS. 3A and 3B compare and contrast the conventional design of program development and the program development in various embodiments as described herein.

FIG. 3A shows an example of a conventional design flow of program development. In the example of FIG. 3A, there are four front end pages: A, B, C and D. For example, front end page A is configured to present a personalized greeting and a current offer associated with a product sold by merchant ACME, front end page B is configured to present a personalized greeting and an image, front end page C is configured to present a personalized greeting and a randomly selected piece of text from a set of predetermined pieces of text, and front end page D is configured to present a current set of images. Page A, page B, and page C all need data from data entity DAL2 in the data layer. In the program development process of this conventional design, each of pages A, B and C is uniquely related to its respective corresponding business logic entity BLL1, BLL2, and BLL3. Each of pages A, B and C needs to acquire the data in DAL2. For example, BLL1 includes program code that is configured to obtain the dynamic data needed by front end page A associated with the personalized greeting from data entity DAL2 and to obtain the dynamic data associated with the current offer associated with a product sold by merchant ACME from data entity DAL1. BLL2 includes program code that is configured to obtain the dynamic data needed by front end page B associated with the personalized greeting from data entity DAL2. BLL2 also includes markup language that can be used to obtain the image that is to be presented at front end page B. BLL3 includes program code that is configured to obtain the dynamic data needed by front end page C associated with the personalized greeting from data entity DAL2 and to obtain the dynamic data associated with the current set of images from data entity DAL3. BLL3 also includes markup language that can be used to obtain the randomly selected piece of text from a set of predetermined pieces of text to be presented at front end page C. Put another way, in the conventional design, obtaining the same data for N different pages requires writing the same code N times. As a result, the conventional design fails to take advantage of code reusability and could lead to greater maintenance costs.

FIG. 3B shows an embodiment of a design flow of program development in accordance with various embodiments described herein. In the example of FIG. 3B, there are four front end pages: A, B, C and D. Similar to the examples provided in FIG. 3A, front end page A is configured to present a personalized greeting and a current offer associated with a product sold by merchant ACME, front end page B is configured to present a personalized greeting and an image, front end page C is configured to present a personalized greeting and a randomly selected piece of text from a set of predetermined pieces of text, and front end page D is configured to present a set of images. In contrast to the front end pages of FIG. 3A, in the program development process of FIG. 3B, each of pages A, B and C no longer uniquely corresponds to one of business logic entity BLL1, BLL2 and BLL3. Rather, each front end page need only include the tag identifiers corresponding to the tag entities that are configured to obtain data that is needed by the front end page. Since pages A, B and C require the same data of a personalized greeting, each of pages A, B, and C can include the same tag identifier that calls the same tag entity. In the example of FIG. 3B, the tag identifier associated with the tag entity of “tag2” is configured to obtain a personalized greeting for a visitor to the front end page from the data layer. As such, each of pages A, B, and C includes the tag identifier for tag entity “tag2” as shown in the figure. (Note: The call relationships between the other pages and the tag entity are not shown in the figure, nor are the access relationships of the other tag entities vis-à-vis the data layer.) In some embodiments, each of pages A, B, and C calls the specialized tag entity pool layer using the tag identifier for tag entity “tag2” and the specialized tag entity pool layer is configured to obtain tag entity “tag2” for each of the pages. As shown in the example, in some embodiments, the specialized tag entity pool layer and/or the associated tags are neither part of the front end or the back end, but comprise a middle layer that is accessible to both the front end and the back end. For example, the program code included in the tag entity of “tag2” can be stored as an XML file such as the example XML file described above. In rendering one or more of pages A, B, and C (e.g., in response to corresponding requests for the front end pages), for each front end page that is requested, the tag identifier corresponding to the tag entity of “tag2” is confirmed and then used as a basis for calling the corresponding tag entity. The necessary data is obtained by executing the tag entity of “tag2.” As such, in various embodiments, a tag entity can be reused by multiple front end pages, thereby avoiding the need to write the same code for different front end pages.

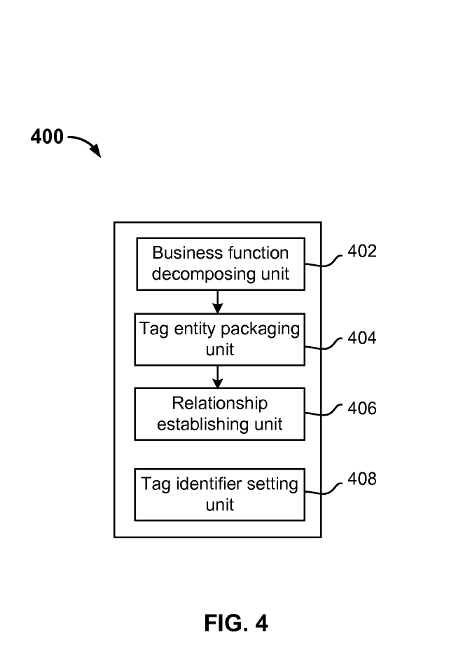

FIG. 4 is a diagram showing an embodiment of a system for tag-based program development. In the example, system 400 includes business function decomposing unit 402, tag entity packaging unit 404, relationship establishing unit 406, and tag identifier setting unit 408.

The units can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Business function decomposing unit 402 is configured to decompose business functions into basic function units according to the business needs corresponding to respective front end pages.

Tag entity packaging unit 404 is configured to package basic function units as tag entities.

Relationship establishing unit 406 is configured to establish corresponding relationships between the tag entities and tag identifiers.

Tag identifier setting unit 408 is configured to include in data associated with a front end page a tag identifier at a location that uses data layer data that is configured to be obtained by a tag entity associated with the tag identifier.

In some embodiments, business function decomposing unit 402, tag entity packaging unit 404, and relationship establishing unit 406 are included in the category of program back end development. In some embodiments, tag identifier setting unit 408 is included in the category of front end page development. In some embodiments, process 200 of FIG. 2 may be implemented at the units of system 400. While the example of FIG. 4 shows business function decomposing unit 402, tag entity packaging unit 404, relationship establishing unit 406, and tag identifier setting unit 408 implemented at a single device, in other embodiments, business function decomposing unit 402, tag entity packaging unit 404, relationship establishing unit 406, and tag identifier setting unit 408 can be implemented across one or more devices.

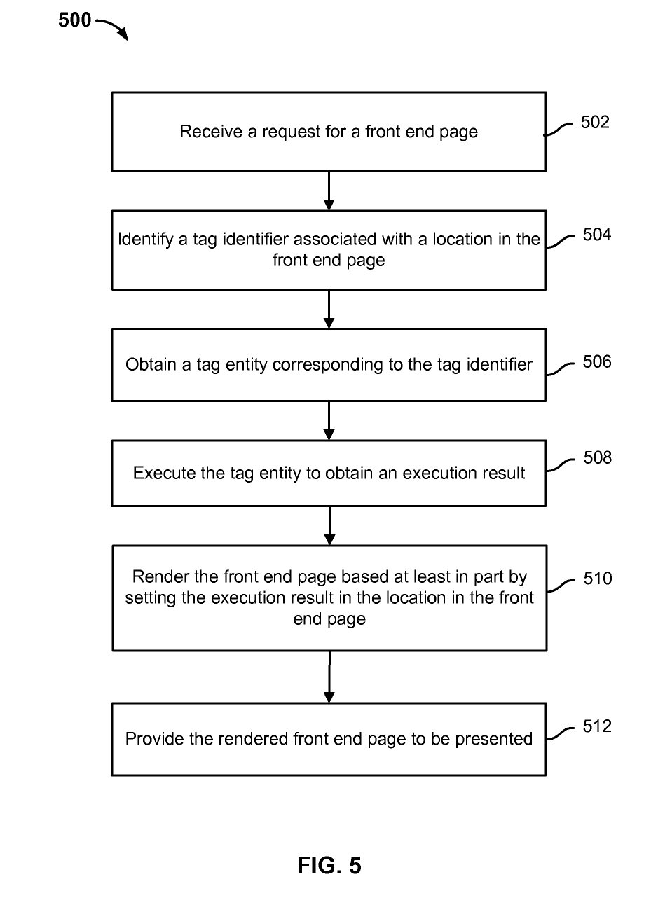

FIG. 5 is a flow diagram showing an embodiment of a process of using tag-based program development. In some embodiments, process 500 is implemented at system 100 of FIG. 1.

At 502, a request for a front end page is received.

A request for a front end page is sent to a (e.g., web) server in response to a user action at a user device. For example, the user action comprises a page visitor's selection of a hyperlink or an input of a uniform resource locator (URL) associated with the front end page at the address field of a web browser. In various embodiments, the front end page is not pre-stored (e.g., cached) at the server but is rather rendered in response to a request for the front end page.

There are at least two types of rendering associated with presenting the front end page. The first type of rendering is associated with rendering static content. For example, static content includes text. The second type of rendering is associated with rendering dynamic content. Rendering static content associated with a front end page is often performed in the same manner for each request for the front end page. Rendering dynamic content associated with the front end page may be different for each request for the front end page. For example, rendering dynamic content may entail obtaining data from a corresponding data layer in a manner that depends on a time and/or an identity of the page visitor associated with the request for the front end page. The obtained data may therefore vary depending on when the request for the front end page is received and the specific page visitor associated with the request. For example, the front end page to be rendered includes the following content: “Hello! **** (name). Welcome to our store. Our special offer today is **** (name of apparel).” The starred sections (“****”) of this page represent locations in the front end page for variables (pieces of dynamic content) because page visitors have different names and the name of the special offer apparel may vary according to different visit dates. As such, the values of the variables of the front end page are to be obtained via a data layer. The remaining static text sections of the front end page will remain unchanged regardless of the name of the page visitor and/or the time of the page request. As such, the rendering of the dynamic content at the front end page will require data processing, while the rendering of the static text can be performed by interpreting the markup language associated with the front end page, for example.

In various embodiments, at least some of the dynamic content associated with a front end page is obtained from the data layer using a tag identifier. For example, each variable to be rendered in the front end page is to be obtained by a respective tag identifier. As such, the data associated with the front end page includes a tag identifier at each location in the front end page in which a variable is to be obtained from the data layer and presented at the rendered front end page.

In some embodiments, static content associated with a front end page is not associated with a tag identifier as it does not need to be obtained from the data layer.

At 504, a tag identifier associated with a location in the front end page is identified.

Data associated with the front end page may or may not have a tag identifier set within it. The data associated with the requested front end page is analyzed to determine whether or not it includes a tag identifier. In various embodiments, one or more tag identifiers set in the data associated with a front end page each represents a variable that is configured to be obtained by the tag identifier from the data layer.

Referring to the above example in which the front end page to be rendered includes the following content: “Hello! **** (name). Welcome to our store. Our special offer today is **** (name of apparel),” a tag identifier would be set in the “**** (name)” location of the front end page data and a different tag identifier would be set in the “**** (name of apparel)” location of the front end page data. In rendering the front end page, each of the two tag identifiers would be used to execute the corresponding tag entities to obtain the corresponding dynamic/variable data from the data layer. Specifically, for example, the “name” variable data can be obtained from a name database at which the page visitor had pre-registered his or her name and the “name of apparel” variable data can be acquired from a specially-priced apparel database that is set up and regularly updated by a merchant associated with the front end page.

The following is one example technique of identifying a tag identifier in the front end page: the various page elements of the front end page are decomposed and formed into an abstract syntax tree, e.g., a Document Object Model (DOM) tree. Then, a pre-established definition of a tag identifier is compared to the various page elements to identify those that are associated with a tag identifier.

The static data of the front end page other than the tag identifiers can be rendered using a conventional technique.

At 506, a tag entity corresponding to the tag identifier is obtained.

After each tag identifier is identified within the data of the requested front end page, the tag entity corresponding to each tag identifier is identified from stored corresponding relationships between tag identifiers and tag entities. In some embodiments, the corresponding relationships between tag identifiers and tag entities are registered at a specialized tag entity pool logic layer. In some embodiments, the specialized tag entity pool logic layer is called to obtain the tag entity corresponding to each tag identifier of the front end page.

In some embodiments, the tag entities and their corresponding tag identifiers were generated using a process such as process 200.

At 508, the tag entity is executed to obtain an execution result.

Then the tag entity, comprising a set of computer program code, obtained for each tag identifier, is executed to obtain a corresponding piece of variable data from the data layer as the execution result.

Referring to the above example in which the front end page to be rendered includes the following content: “Hello! **** (name). Welcome to our store. Our special offer today is **** (name of apparel),” the tag identifier in the name location corresponds to a tag entity that is configured to find the appropriate “name” data in the name database and to return the found “name.” In some embodiments, the request for the front end page includes identifying information (e.g., a cookie) associated with the page visitor and the tag entity can use the page visitor identifying information to obtain the corresponding name from the name database. For example, the cookie that is included in the request for the front end page can be verified (e.g., to avoid tampering). For example, the request may include user identifying information such as a unique user identifier that the tag entity can use to find the corresponding user name in the name database. Furthermore, the tag identifier in the apparel name location corresponds to a tag entity that is configured to obtain apparel name data from a specially-priced apparel database that is set up and regularly updated by a merchant associated with the front end page and to return the found “name of apparel.” In some embodiments, the request for the front end page includes time information associated with the time at which the request for the front end page was made/sent and the tag entity can use the time information to obtain the apparel name that corresponds to the time information from the specially-priced apparel database. For example, the request may include a timestamp associated with when the request was made/sent that the tag entity can use to find an offer on apparel that is valid during a period that includes the timestamp.

At 510, the front end page is rendered based at least in part by setting the execution result in the location in the front end page.

To complete the rendering of the front end page, each piece of variable data returned by a tag entity is set/inserted into the rendered front end page at the location of the corresponding tag identifier. The completely rendered front end page also includes the rendered static data, if any.

Referring to the above example in which the front end page to be rendered includes the following content: “Hello! **** (name). Welcome to our store. Our special offer today is **** (name of apparel),” if the returned “name” data were “James” and if the returned “name of apparel” data were “cashmere sweater,” then the rendered front end page would include: “Hello! James. Welcome to our store. Our special offer today is cashmere sweater.”

In various embodiments, the rendering of the dynamic/variable content of the front end page and the rendering of the static content of the front end page may proceed in various manners and/or sequences. The static content of the front end page can be rendered any time after the request for the front end page is received while the dynamic/variable content of the front end page can be rendered only after the appropriate data has been obtained by executing the tag entity. In some embodiments, the rendering of the dynamic/variable content of the front end page and the rendering of the static content of the front end page may proceed independently of each other or in a manner that is related. Below are three example ways in which rendering of the dynamic/variable and static content of the front end page may proceed:

In a first example, rendering of both the dynamic/variable and static content of the front end page takes place simultaneously only after the dynamic/variable has been completely obtained by executing one or more tag entities.

In a second example, the static content and the dynamic/variable content of the front end page are alternately rendered until the entire page is completed rendered. For example, the static content of the front end page is rendered until a tag identifier is identified in the data of the front end page. Then the dynamic/variable data associated with the identified tag identifier is obtained and rendered. After the dynamic/variable data associated with the identified tag identifier is obtained and rendered, the static content of the front end page is continued to be rendered until another tag identifier, if any, is identified in the data of the front end page. The static content and the dynamic/variable content of the front end page are alternately rendered in this manner until the entire front end page is rendered.

In a third example, the static content and the dynamic/variable content of the front end page are rendered without mutual interference. Put another way, the static content and the dynamic/variable content of the front end page are rendered in parallel and independent of each other. Conventionally, the rendering of the front end page has to wait until after the business logic process corresponding to the front end page is completed because the front end page is related to a certain business logic entity. That is, the dynamic/variable data has to be acquired first before rendering of the front end page can be performed. In various embodiments as described herein, the relationships between front end pages and business logic entities have become converted into relationships between tag identifiers in the front end page data and tag entities accessible by a specialized tag entity pool logic layer, which is very flexible. As such, the static content of the front end page can begin rendering immediately after the request for the front end page is received and the dynamic/variable content of the front end page can be obtained and rendered immediately after the request for the front end page is received, which is very efficient.

At 512, the rendered front end page is provided to be presented.

The completely rendered front end page is provided to the source of the request. In various embodiments, the completely rendered front end page can be sent back to the user device from which the request was sent. For example, the completely rendered front end page is presented at the user device from which the request was sent.

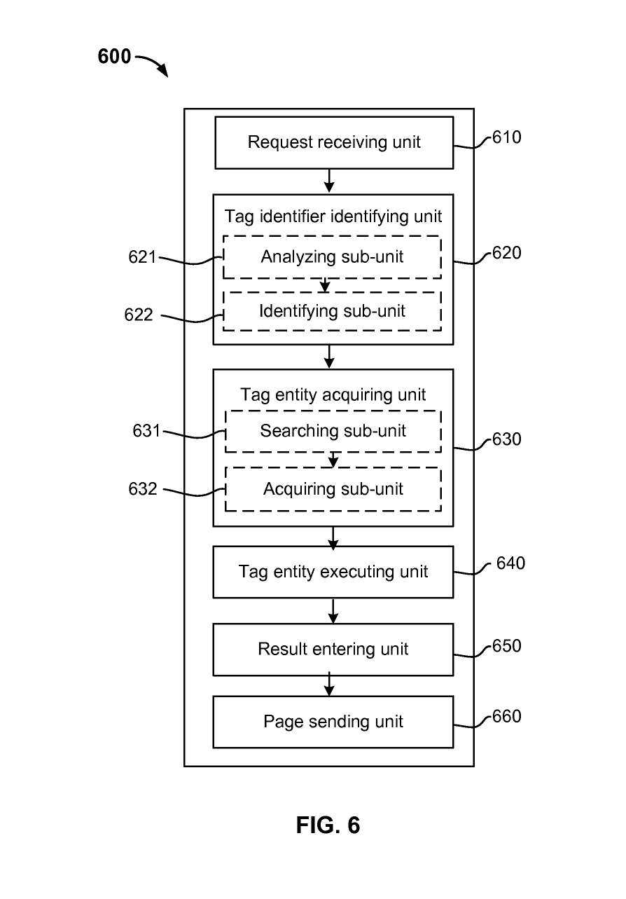

FIG. 6 is a diagram showing an embodiment of a system for using a tag-based program development. In the example, system 600 includes request receiving unit 610, tag identifier identifying unit 620, tag entity acquiring unit 630, tag entity executing unit 640, result entering unit 650, and page sending unit 660.

The units can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Request receiving unit 610 is configured to receive requests for front end pages.

Tag identifier identifying unit 620 is configured to identify one or more tag identifiers in the data of a front end page associated with a request.

Tag entity acquiring unit 630 is configured to obtain the tag entities corresponding to the identified tag identifier(s).

Tag entity executing unit 640 is configured to execute the tag entities.

Result entering unit 650 is configured to set the results of executing the tag entities into the locations of their corresponding tag identifiers during the rendering of the front end page.

Page sending unit 660 is configured to send the completely rendered front end page in response to a corresponding request.

In some embodiments, system 600 further includes a rendering unit (not shown in the diagram). The rendering unit is configured to render the static content of a front end page and also render the dynamic/variable content obtained by the tag entities for the front end page. The rendering unit is configured to insert the execution results of the tag entities set by result entering unit 650 at the locations in the front end page corresponding to the corresponding tag identifiers.

In system 600, tag entity acquiring unit 630 further comprises searching sub-unit 631 and acquiring sub-unit 632. Searching sub-unit 631 is configured to use tag identifiers to search through stored corresponding relationships between tag identifiers and tag entities. In some embodiments, the corresponding relationships between tag identifiers and tag entities were established based on the tag entities that were registered at a specialized tag entity pool logic layer. Acquiring sub-unit 632 is configured to obtain tag entities corresponding to the identified tag identifiers from the specialized tag entity pool logic layer. In system 600, tag identifier identifying unit 620 further comprises analyzing sub-unit 621 and identifying sub-unit 622. Analyzing sub-unit 621 is configured to analyze the page elements of the front end page associated with a request and configured to create a DOM tree using the page elements. Identifying sub-unit 622 is configured to identify the tag identifiers from the DOM tree.

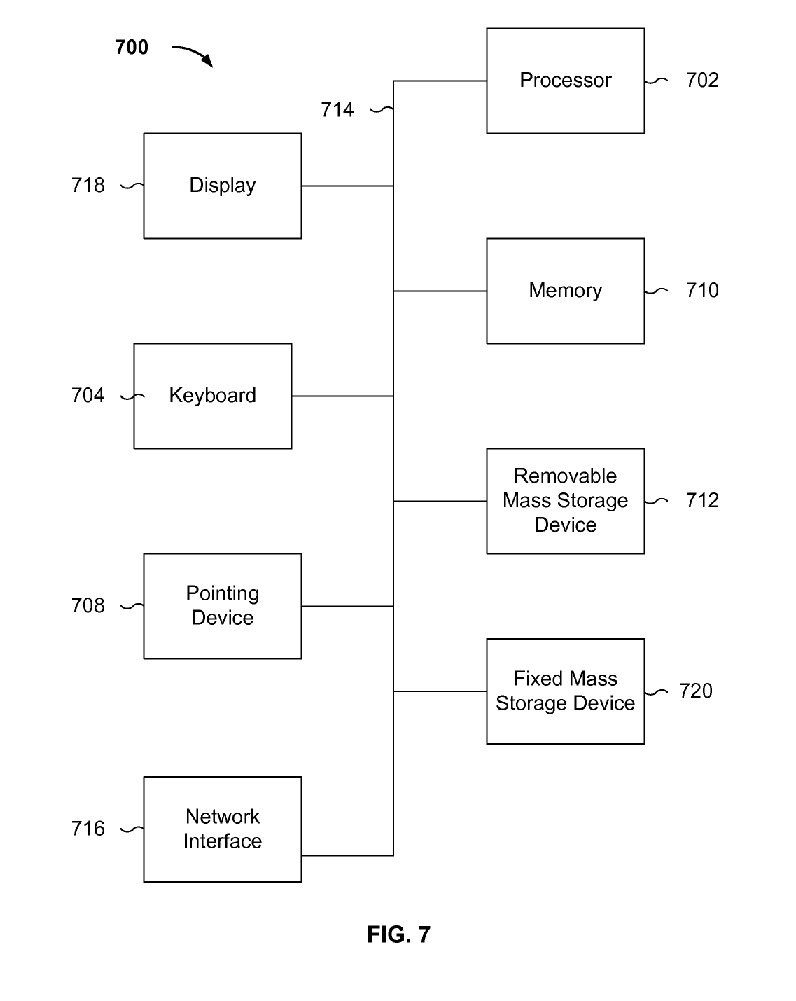

FIG. 7 is a functional diagram illustrating an embodiment of a programmed computer system for using a tag-based program development. As will be apparent, other computer system architectures and configurations can be used for using a tag-based program development. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In some embodiments, processor 702 includes and/or is used to use a tag-based program development.

Processor 702 is coupled bi-directionally with memory 710, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer readable storage media, described below, depending on whether, for example, data access needs to be bi-directional or uni-directional. For example, processor 702 can also directly and very rapidly retrieve and store frequently needed data in a cache memory (not shown).

A removable mass storage device 712 provides additional data storage capacity for the computer system 700 and is coupled either bi-directionally (read/write) or uni-directionally (read only) to processor 702. For example, storage 712 can also include computer readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display 718, a network interface 716, a keyboard 704, and a pointing device 708, as well as an auxiliary input/output device interface, a sound card, speakers, and other subsystems as needed. For example, the pointing device 708 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive a request for a front end page;
identify a tag identifier associated with a location in the front end page;
obtain a tag entity corresponding to the tag identifier;
execute the tag entity to obtain an execution result;
render the front end page based at least in part by setting the execution result in the location in the front end page; and
provide the rendered front end page to be presented; and
one or more memories coupled to the one or more processors and configured to provide the one or more processors with instructions.

2. The system of claim 1, wherein the one or more processors are further configured to:
decompose a function corresponding to the front end page into one or more basic is function units;
package the one or more basic function units into corresponding one or more tag entities;
establish corresponding relationships between corresponding tag identifiers and the one or more tag entities; and
include in data associated with the front end page the tag identifier corresponding to the tag entity at the location in the front end page that uses data layer data that is configured to be obtained by the tag entity.

3. The system of claim 2, wherein the corresponding relationships between the corresponding tag identifiers and the one or more tag entities are accessible by a specialized tag entity pool.

4. The system of claim 1, wherein to identify the tag identifier associated with the location in the front end page comprises to:
create a document object model (DOM) tree using page elements associated with the front end page; and
compare a predetermined tag identifier definition with the DOM tree to identify a page element associated with the tag identifier.

5. The system of claim 1, wherein to obtain the tag entity corresponding to the tag identifier comprises to query a specialized tag entity pool.

6. The system of claim 1, wherein to execute the tag entity to obtain the execution result comprises the executed tag entity configured to obtain a data value from a data layer and wherein the execution result comprises the data value.

7. The system of claim 1, wherein to render the front end page further comprises to render content associated with the front end page that is not associated with the tag identifier.

8. The system of claim 1, wherein to provide the rendered front end page comprises to send the front end page to a client device associated with sending the request for the front end page.

9. A method, comprising:
receiving a request for a front end page;
identifying a tag identifier associated with a location in the front end page;
obtaining, using one or more processors, a tag entity corresponding to the tag identifier;
executing the tag entity to obtain an execution result;
rendering the front end page based at least in part by setting the execution result in the location in the front end page; and
providing the rendered front end page to be presented.

10. The method of claim 9, further comprising:
decomposing a function corresponding to the front end page into one or more basic function units;
packaging the one or more basic function units into corresponding one or more tag entities;
establishing corresponding relationships between corresponding tag identifiers and the one or more tag entities; and
including in data associated with the front end page the tag identifier corresponding to the tag entity at the location in the front end page that uses data layer data that is configured to be obtained by the tag entity.

11. The method of claim 10, wherein the corresponding relationships between the corresponding tag identifiers and the one or more tag entities are accessible by a specialized tag entity pool.

12. The method of claim 9, wherein identifying the tag identifier associated with the location in the front end page comprises:
creating a document object model (DOM) tree using page elements associated with the front end page; and
comparing a predetermined tag identifier definition with the DOM tree to identify a page element associated with the tag identifier.

13. The method of claim 9, wherein obtaining the tag entity corresponding to the tag identifier comprises querying a specialized tag entity pool.

14. The method of claim 9, wherein executing the tag entity to obtain the execution result comprises the executed tag entity configured to obtain a data value from a data layer and wherein the execution result comprises the data value.

15. The method of claim 9, wherein rendering the front end page further comprises rendering content associated with the front end page that is not associated with the tag identifier.

16. The method of claim 9, wherein providing the rendered front end page comprises sending the front end page to a client device associated with sending the request for the front end page.

17. A computer program product, the computer program product being embodied in a non-transitory computer readable storage medium and comprising computer instructions for:
receiving a request for a front end page;
identifying a tag identifier associated with a location in the front end page;
obtaining a tag entity corresponding to the tag identifier;
executing the tag entity to obtain an execution result;
rendering the front end page based at least in part by setting the execution result in the location in the front end page; and
providing the rendered front end page to be presented.

18. The computer program product of claim 17, further comprising:
decomposing a function corresponding to the front end page into one or more basic function units;
packaging the one or more basic function units into corresponding one or more tag entities;
establishing corresponding relationships between corresponding tag identifiers and the one or more tag entities; and
including in data associated with the front end page the tag identifier corresponding to the tag entity at the location in the front end page that uses data layer data that is configured to be obtained by the tag entity.

19. The computer program product of claim 18, wherein the corresponding relationships between the corresponding tag identifiers and the one or more tag entities are accessible by a specialized tag entity pool.

20. The computer program product of claim 17, wherein identifying the tag identifier associated with the location in the front end page comprises:
creating a document object model (DOM) tree using page elements associated with the front end page; and
comparing a predetermined tag identifier definition with the DOM tree to identify a page element associated with the tag identifier.
